(19) United States
(12) Patent Application Publication
(10) Pub. No.: US 2010/0058782 A1
(43) Pub. Date: Mar. 11, 2010

(54) ADSORBER AND ITS USE IN HEAT ACCUMULATORS AND HEAT PUMPS, OR REFRIGERATORS

(76) Inventors: Ivan Brovchenko, Bochum (DE); Alla Oleinikova, Bochum (DE); Alfons Geiger, Dortmund (DE); Ferdinand Schmidt, Freiburg (DE)

Correspondence Address: JACOBSON HOLMAN PLLC, 400 SEVENTH STREET N.W., SUITE 600, WASHINGTON, DC, 20004, US

(21) Appl. No.: 12/309,767

(22) PCT Filed: Aug. 13, 2007
(86) PCT No.: PCT/EP2007/007148

§ 371 Date: Nov. 17, 2009

(30) Foreign Application Priority Data
Aug. 11, 2006 (DE) 10 2006 037 528.9
Sep. 18, 2006 (DE) 10 2006 043 672.5

(51) Int. Cl. F25B 15/00; B01J 20/22; B01J 20/26

(52) U.S. Cl. 62/112; 502/401; 502/402; 502/404

(57) ABSTRACT

The invention relates to an adsorbent having a porous carrier structure, the pore walls of which are coated with a material which displays a temperature-induced reversible switching-over of the surface properties from hydrophilic to hydrophobic behaviour, the hydrophobicity increasing with rising temperature.

The invention relates to an absorbent having a porous carrier structure, the pore walls of which are coated with a material which displays a temperature-induced, reversible switching-over of the surface properties from hydrophilic to hydrophobic behaviour, the hydrophobicity increasing with rising temperature. The adsorbent according to the invention is used in heat reservoirs and heat pumps and also in refrigerators.

Adsorption heat reservoirs offer the possibility of almost loss-free storage of heat, in particular in the temperature range up to 250° C., over long periods of time. One requirement on such long-term heat reservoirs resides in particular in connection with solar-thermal heating of buildings in regions of the earth with a high seasonal variation in solar radiation, i.e. in all regions remote from the equator. The greatest supply of solar heat in the course of the year from thermal collectors arises here in summer but the demand for heating is predominantly in winter. In the sense of the design of a sustained energy supply which is based increasingly on renewable energy sources, seasonal heat storage for heating buildings is desirable and is a prerequisite for achieving high solar cover proportions in solar-thermal heating of buildings.

Heat storage in the temperature range up to approx. 250° C. is also an important topic for many other applications. For example in the case of decentralised current production in plants with power-heat coupling (PHC), the problem typically exists therefore of different temporal requirement profiles for current and heat. In order to be able to operate these plants producing current and to be able to use the generated heat, this heat must be stored in the interim until it is needed. For this purpose, heat reservoirs with a high energy density and high efficiency, i.e. low heat losses, are required.

A variant known from the state of the art is based on the fact that the temperature dependency of the water adsorption in porous materials is used for heat storage. However, in addition to unsuitable pressure conditions, a flat temperature course of the adsorption isobars represents a substantial restriction in the technical application of this variant. The reason for this is the blurring of the capillary condensation/capillary evaporation transition, i.e. of a liquid-gas phase transition within the pores, because of a wide pore size distribution and high heterogeneity of the pore surface. This leads to the fact that the capillary condensation or capillary evaporation takes place at temperatures and pressures which depend greatly upon the pore size.

For application in adsorption heat pumps and refrigerators there are comparable requirements on the adsorbent as for heat reservoirs. Here also, relative to adsorbents known from the state of the art, a greater load conversion in a narrow temperature range (at constant pressure) is desirable.

It was therefore the object of the present invention to provide adsorbents which do not have these disadvantages known from the state of the art and enable a temperature-induced liquid-gas phase transition within a narrow temperature and pressure interval. For application in adsorption heat pumps and refrigerators, adsorbents are intended to be provided in addition which enable constructional simplifications of the machines and make it possible in particular to economise on the condenser as a separate component.

This object is achieved by the adsorbent having the features of claim 1. Uses according to the invention are mentioned in claims 13 and 16. The further dependent claims reveal advantageous developments.

According to the invention, an adsorbent is provided which has a porous carrier structure, the pore walls being coated with at least one polymer, oligomer and/or blends hereof. The coating thereby enables a temperature-induced, reversible switching-over of the surface properties from hydrophilic to hydrophobic behaviour, the hydrophobicity increasing with rising temperature.

The possibility of changing the hydrophily or hydrophoby of the pore walls opens up a route for controlled condensation and evaporation of water in porous materials. Altered wetting properties of the pore walls can be achieved by chemical treatment, by irradiation and by temperature variation. The latter can be achieved by covering the surfaces with a thin film of the coating according to the invention which displays a reversible transition with increasing temperature, which changes the properties of the surface from hydrophilic to hydrophobic.

The adsorbent according to the invention displays a rapid change in the contact angle of a water drop situated thereon if a defined temperature is exceeded. If a contact angle of approx 90° is reached, then the switch-over from capillary condensation to capillary evaporation is effected.

The adsorbent according to the invention is distinguished, relative to the materials known from the state of the art, in particular in that the liquid-gas phase transition in the pores takes place synchronously, despite the different pore size, within a narrow temperature and pressure interval.

The adsorbent according to the invention enables efficient heat adsorption and dissipation within a narrow, technically advantageous temperature and pressure range by using the liquid-gas phase transition in sufficiently hard porous materials. The position of the abrupt capillary condensation/evaporation transition with respect to temperature and pressure can be adjusted by corresponding choice of the coating material.

As a result of the switchable surface of the pore walls during an increase in temperature from hydrophilic to hydrophobic behaviour, emptying the pores is achieved already at a lower heating temperature and hence over a lower temperature range. The temperature of the emptying can also be adjusted here by the choice of coating material.

A further important advantage is that the heat storage effect, in the case of the adsorbent according to the invention, is based essentially on the condensation enthalpy and not on the interaction energy with the pore walls.

In a preferred embodiment of the present invention, the coating of the pore walls contains at least LCST polymer. This is selected for particular preference from the group comprising N-substituted poly(meth)acrylamides, poly(N-vinylcaprolactam), polyalkylene oxides, polyalkylene glycols, poly(vinylalkyl ether), hydroxyalkyl celluloses and also copolymers or blends thereof.

In a further preferred embodiment, the coating contains at least one denaturable biopolymer, in particular from the group of peptides.

The coating material can be chosen such that the hydrophobicity increases constantly with rising temperature. However it is likewise also possible that the hydrophobicity increases rapidly within a narrow temperature range.

The layer thickness of the coating depends greatly upon the coating material which is used. The layer thickness is thereby determined by the polymer- or oligomer chains which are used. By means of hydration, the layer thickness can be increased by approx. the factor 2. The minimum layer thickness is thereby in the dry, i.e. water-free state, at approx 15 Å, e.g. in the case where small peptides are used as coating material. The maximum layer thickness is limited by the pore size of the carrier material which is used. The upper layer thickness is hence at approx. 200 Å.

The carrier structure can be selected preferably from the group of porous silica glasses or porous carbons, such as e.g. activated carbon. The average pore size of the carrier material should be in a range which makes possible a sufficient pore volume after the coating. The average pore size should therefore be at least 50 Å. This does not preclude pores with smaller diameters also being present in the carrier structure which are however not then available for water incorporation. An upper limit of the average pore size is at 2000 Å since, above this pore size, problems occur in the evaporation due to the metastability so that the evaporation process takes up too much time.

The porosity of the carrier structure should be as high as possible. For common carrier structures, such as silica glasses or activated carbons, this is in a range of 0.2 to 0.6 cm³/g.

The specific surface of the carrier structure is preferably in a range of 100 to 1000 m²/g.

The adsorbent according to the invention is used in heat reservoirs for adsorption of water.

The adsorbent according to the invention is likewise used in heat pumps and refrigerators. In these applications, the adsorbent according to the invention offers the great advantage that the adsorbent is hydrophobic above a threshold temperature and hence a temperature range for the desorption is no longer required. The condensation can take place directly then on the adsorbent surface and the condensation heat can be supplied again directly to the desorption process so that a condenser is no longer required as a separate component. As a result, the complexity of the plant is reduced and simpler hydraulic circuits and also a simplified operational control become possible (in particular in plants which have a plurality of adsorbers).

The subject according to the invention is intended to be explained in more detail with reference to the subsequent Figures without wishing to restrict said subject to the special embodiments shown here.

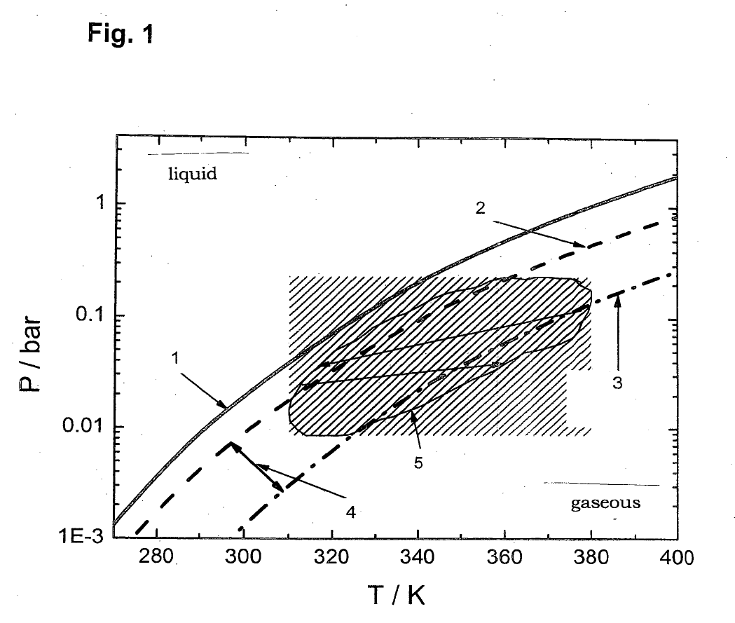

FIG. 1 shows, with reference to a diagram, the dependency of the vapour pressure of water upon the temperature in the case of adsorbents known from the state of the art.

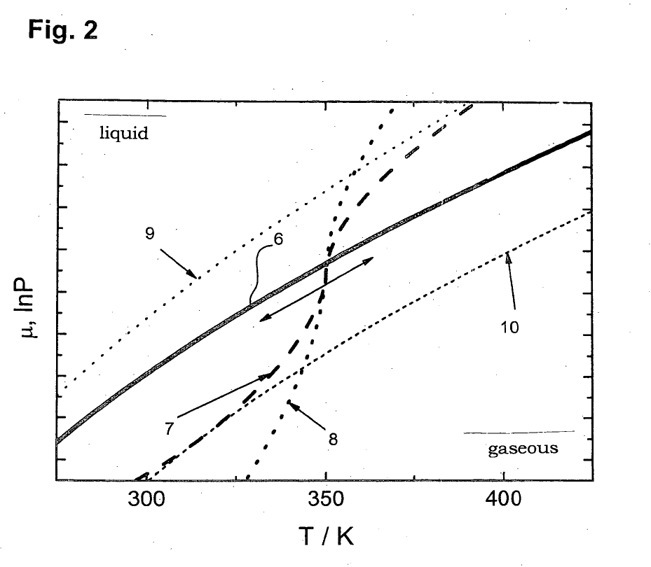

FIG. 2 shows, with reference to a diagram, the dependency of the vapour pressure of water upon the temperature of adsorbents according to the invention.

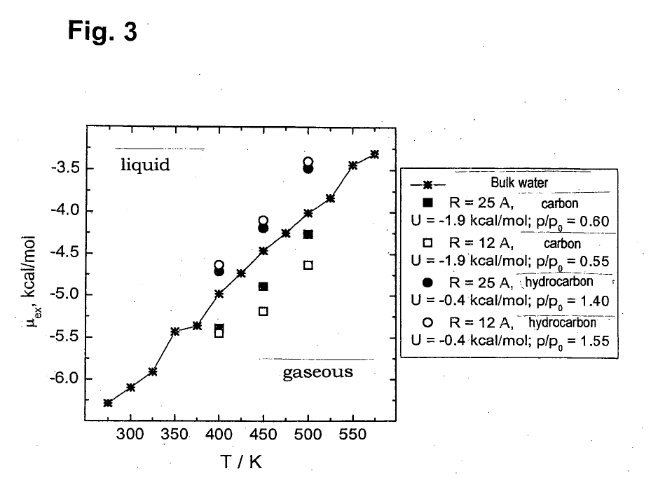

FIG. 3 shows a μ-T phase diagram of bulk water and water in cylindrical pores.

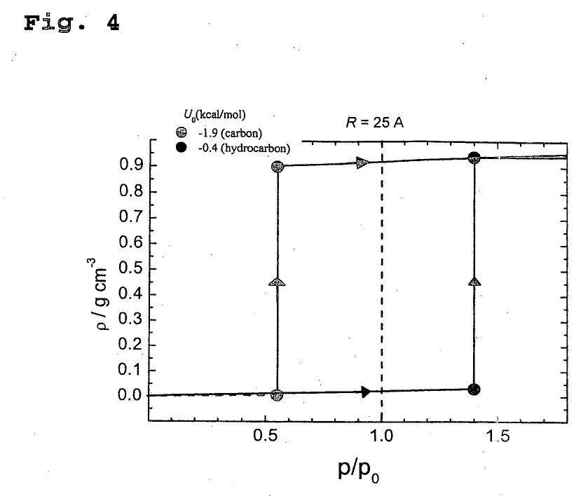

FIG. 4 shows a diagram which shows a gas-liquid phase transition in two pores of differing hydrophily.

The vapour pressure of water with porous materials known from the state of the art is shown with reference to FIG. 1 as a function of the temperature. There are hereby denoted:
1 bulk water
2 water in large pores
3 water in small pores
4 pore size distribution
5 operating range

The materials hereby have a temperature-independent hydrophily of the pore walls. The pores are filled with liquid when the latter is in equilibrium with saturated vapour of bulk water. Drying of the pores by heating, i.e. a movement in the diagram from left to right, can only be effected at pressures below the vapour pressure of the bulk liquid. This is shown clearly by the region in the diagram in broken lines. The liquid-vapour transition is greatly extended here because of the wide pore size distribution in real materials. This limits the applicability of porous materials for the heat storage.

In FIG. 2, a diagram corresponding to FIG. 1 for an adsorbent according to the invention is represented. There are denoted herein:
6 bulk water
7 large pores
8 small pores
9 large, hydrophobic pores
10 large, hydrophilic pores

The latter shows a hydrophoby which increases with rising temperature. This can be detected in FIG. 2 in that the chemical potential of the water in the pores of the adsorbent with the hydrophilic/hydrophobic coating is higher from a specific temperature than the chemical potential of liquid water (as bulk phase) at the same temperature. The water molecules then preferably form water drops out with the adsorbent and do not remain in the pores of the adsorbent. The pores are filled at low temperatures and saturation vapour pressure of the bulk liquid until the interaction between water and pore wall exceeds a threshold value when heated. In the present diagram this threshold value is at approx. 350 K. The threshold value U_{c} of the potential depth is at −1 kcal/mol, which corresponds to a surface hydrophobicity between that of carbon and hydrocarbons. Emptying of the pores can be, achieved by heating at saturation vapour pressure or thereunder, i.e. in the present case 350 K by heating the latter. If U reaches the threshold value, a sharp liquid-gas phase transition takes place virtually simultaneously in the pores of all sizes.

The phenomenon represented in FIG. 2 and described previously means for the application of the adsorbent in refrigerators that the vapour emerging from the adsorbent would still condense within the adsorber. If this takes place already on the surface of the adsorbent which can be present as a pellet or as a layer, for example on a heat exchanger surface, the condensation heat is supplied directly again to the adsorbent, i.e. the quantity of heat which must be supplied for desorption via the heat exchanger, is greatly reduced. In the case of adsorbents with a hydrophilic/hydrophobic transition, the temperature range which is required for desorption is 0, i.e. desorption and condensation are effected at the same temperature level, as a result of which the condensation heat can be used directly for the desorption. During absorption at a low temperature, a certain temperature range is nevertheless usable since the adsorbent at a low temperature is hydrophilic and hence leads to a vapour pressure drop relative to bulk water. With respect to the energy balance of a refrigerator, it can be established using the adsorbent according to the invention that, as heat flow at the average temperature level, i.e. out of the system, only adsorption heat still exists. This quantity of heat must correspond to the sum of evaporation heat and desorption heat which flow into the system. Since the desorption heat is very low due to the condensation heat remaining in the adsorber, a very high efficiency (COP) can thus be achieved. This resides significantly closer to the COP of the Carnot process than for adsorbents known from the state of the art.

With respect to refrigerators, also the quantities of heat which must be expended or are released during an isosteric heating and cooling are also of great significance. In the case of isosteric heating, a phase transition of the adsorbent according to the invention is effected, i.e. the molecule chains collapse and lump together. This leads to a high effective heat capacity of the adsorbent, i.e. the “perceivable” heat which has a phase change enthalpy but no sorptive enthalpy, is significantly greater than normal. This leads to the fact that a refrigerator with the adsorbent according to the invention can dispense with a condenser so that only the adsorption heat requires to be dissipated to the aftercooler. This confers the advantage that the hydraulic circuitry and operational control of a refrigerator can be significantly simplified.

In FIG. 3, a μ-T phase diagram of bulk water and water in cylindrical pores which were obtained from simulation calculations is represented.

In equilibrium with bulk water at saturation vapour pressure, the carbon-like pores are filled, represented by the dots under the continuous line, with liquid, whereas the hydrophobic pores, represented by the dots above the continuous line, are filled with water vapour. The continuous line indicates the chemical potential of bulk water at the equilibrium line. The dots show the potential of the water at liquid-gas phase equilibrium in different cylinder pores.

In equilibrium with water vapour at saturation vapour pressure of the bulk liquid, the carbon-like pores (U=−1.9 kcal/mol) are filled with liquid, the hydrocarbon pores (U=−0.4 kcal/mol) with water vapour. If the hydrophobicity of the pore walls increases with the temperature, the liquid in the pores evaporates due to a phase transition. This takes place if the depth of the water-wall interaction potential U changes from −1.9 to −0.4 kcal/mol.

FIG. 4 shows, with reference to a diagram, the gas-liquid phase transition in two pores of different hydrophily. The lines represented here describe the adsorption isotherms. The transition takes place at p=p₀ if the chemical potential U₀ is approx. −1.0 kcal/mol.

FIGS. 3 and 4 clarify the following phenomenon. If the hydrophily of the pore walls reduces with increasing temperature and the interaction strength with the water molecules falls below −1 kcal/mol, a capillary evaporation should begin in the pores of all sizes at the same time. Such a synchronous behaviour can be achieved by coating the pore walls with temperature-switchable materials. Such coating materials can be found amongst the substances which display a temperature-induced demixing behaviour in aqueous solution since the latter can be expected also when using as coating material a temperature-induced increase in hydrophobicity, which can be detected for example at a temperature-dependent contact angle of water drops on planar coated surfaces. A material which is suitable in particular in this context is PNIPAM. However also different block copolymers can be used preferably for this purpose.

With respect to a refrigerator, the small temperature range can represent a problem. In FIG. 4, the course of the loading over the relative vapour pressure for a hydrophilic and a hydrophobic cylinder pore is shown. The hydrophobic pore is subjected firstly to a relative vapour pressure greater than 1, which leads to capillary evaporation and condensation on the surface of the adsorbent. The hydrophilic pore is subjected in this example in FIG. 4 to a relative vapour pressure of approx. 0.55. This corresponds to a maximum temperature range of 10 to 13 K. In order to be able to produce as large temperature ranges as possible, the hydrophilically/hydrophobically switching polymer layer is modified such that the capillary condensation in the hydrophobic state is effected at a relative vapour pressure as little as possible above 1, i.e. displays only weakly hydrophobic behaviour, and the capillary condensation is effected in the hydrophilic state already at the lowest possible relative vapour pressure. If the temperature range remains too small despite modification of the polymer layer, cascading of a plurality of adsorbers with materials of different switching temperatures of the polymers enables a higher temperature range of the entire system. The adsorption heat of the adsorbent with the low switching temperature of the polymer is then supplied to the evaporator for an absorber with a higher switching temperature of the polymer, as a result of which the usable temperature range is increased.

1. Adsorbent containing a porous carrier structure, the pore walls being coated with at least one polymer, oligomer and/or blends thereof and this coating displaying a temperature-induced reversible switching-over of the surface properties from hydrophilic to hydrophobic behaviour, the hydrophobicity increasing with rising temperature.

2. Adsorbent according to claim 1, characterised in that the coating contains at least one LCST polymer.

3. Adsorbent according to the preceding claim, characterised in that the LCST polymer is selected from the group comprising N-substituted poly(meth)acrylamides, poly(N-vinylcaprolactam), polyalkylene oxides, polyalkylene glycols, poly(vinylalkyl ether), hydroxyalkyl celluloses and also copolymers or blends thereof.

4. Adsorbent according to claim 1, characterised in that the coating contains at least one denaturable biopolymer.

5. Adsorbent according to the preceding claim, characterised in that the biopolymer is selected from the group of peptides.

6. Adsorbent according to claim 1, characterised in that the hydrophobicity increases constantly with the temperature increase.

7. Adsorbent according to claim 1, characterised in that the hydrophobicity increases rapidly within a narrow temperature range.

8. Adsorbent according to claim 1, characterised in that the coating has a layer thickness in the range of 15 Å to 200 Å.

9. Adsorbent according to claim 1, characterised in that the carrier structure is selected from the group comprising porous silica glasses and porous carbons, in particular activated carbon.

10. Adsorbent according to claim 1, characterised in that the carrier structure has an average pore size in the range of 50 Å to 2000 Å.

11. Adsorbent according to claim 1, characterised in that the carrier structure has a porosity in the range of 0.2 to 0.6 cm³/g.

12. Adsorbent according to claim 1, characterised in that the carrier structure has a specific surface of at least 100 to 1000 m²/g.

13. Use of the adsorbent according to claim 1 in heat pumps and heat reservoirs.

14. Use according to the preceding claim for the adsorption of water.

15. Use according to claim 11, characterised in that the temperature for switching-over and/or the contact angle is adjusted by functionalising the at least one polymer.

16. Use of the adsorbent according to claim 1 in refrigerators.

17. Use of the adsorbent according to claim 16, characterised in that the refrigerators operate without condensers.

18. Use of the adsorbent according to the preceding claim, characterised in that the adsorbent is introduced into a heat exchanger in such a manner that the desorbed vapour within the heat exchanger unit can condense on the surface of the adsorbent and the condensate can discharge and be supplied to a condensate return to the evaporator.
